(19) United States
(12) Patent Application Publication
(10) Pub. No.: US 2020/0168063 A1
(43) Pub. Date: May 28, 2020

(54) SYSTEM AND METHOD FOR SUPPRESSION OF PHYSICAL THREATS

(71) Applicant: Livefree Emergency Response, Inc., Pocatello, ID (US)

(72) Inventors: Jacob H. Chandler, Pocatello, ID (US); Joshua K. Chandler, Idaho Falls, ID (US)

(21) Appl. No.: 16/240,651

(22) Filed: Jan. 4, 2019

Related U.S. Application Data
(60) Provisional application No. 62/772,086, filed on Nov. 27, 2018.

(51) Int. Cl. G08B 13/196; G07C 9/00; F42B 12/46

(52) U.S. Cl. CPC G08B 13/19608; F42B 12/46; G08B 13/19691; G07C 9/00174

(57) ABSTRACT

Methods and systems for the suppression of physical threats are provided. In certain embodiments, a method includes activating an alert that indicates that a threat is present within an area. The method also includes receiving the alert at a monitoring device. The method further includes identifying a location of the threat based on monitoring information acquired by the monitoring device. The method additionally includes displaying information for the threat at the monitoring device. Further, the method includes remotely controlling a threat contact device to interfere with actions of the threat based on the information for the threat.

### CROSS-REFERENCES TO RELATED APPLICATION

This application claims the benefit of U.S. Provisional Patent Application No. 62/772,086, filed Nov. 27, 2018, which is incorporated herein by reference.

### FIELD

The subject matter disclosed herein relates to security systems and is more particularly related to systems and methods for suppressing physical threats.

### BACKGROUND

School shootings, bank robberies, and other acts involving physical threats to large numbers of people and/or to valuable property have been a threat for many years. To deal with these physical threats, some security solutions use physical, armed, security personnel who are constantly present at the protected location. Other security solutions implement technological systems that restrict access to the protected area and/or monitor the area. Technological systems can also alert off-site security personnel. The security personnel can respond to the alert by arriving at the area to address the threat. However, conventional security solutions are often ineffective at efficiently and quickly suppressing a physical threat.

### SUMMARY

The subject matter of the present application has been developed in response to the present state of the art, and in particular, in response to the problems and disadvantages associated with conventional systems for the suppression of physical threats. Accordingly, the subject matter of the present application has been developed to provide methods and systems for the suppression of physical threats that overcomes at least some of the shortcomings of the prior art techniques discussed herein.

Disclosed herein is a method that includes activating an alert that indicates that a threat is present within an area. The method also includes receiving the alert at a monitoring device. The method further includes identifying a location of the threat based on monitoring information acquired by the monitoring device. The method additionally includes displaying information for the threat at the monitoring device. Further, the method includes remotely controlling a threat contact device to interfere with actions of the threat based on the information for the threat. The preceding subject matter of this paragraph characterizes example 1 of the present disclosure.

The threat contact device includes at least one of a neutralizing device and a tagging device. The preceding subject matter of this paragraph characterizes example 2 of the present disclosure, wherein example two also includes the subject matter according to example 1, above.

The method further includes limiting mobility of the threat by locking one or more doors. The preceding subject matter of this paragraph characterizes example 3 of the present disclosure, wherein example 3 also includes the subject matter according to any one of examples 1-2, above.

The method also includes automatically sending notifications to people affected by the threat in response to the alert being activated. The preceding subject matter of this paragraph characterizes example 4 of the present disclosure, wherein example 4 also includes the subject matter according to any one of examples 1-3, above.

The method additionally includes enabling two-way communication between the monitoring device and a device associated with the alert. The preceding subject matter of this paragraph characterizes example 5 of the present disclosure, wherein example 5 also includes the subject matter according to any one of examples 1-4, above.

Further disclosed herein is a system that includes a monitoring module that monitors an area. The system further includes an activation module that sends signals to the monitoring module indicating that a threat exists within the area. The system additionally includes an image sensing module that captures images of the area for use by the monitoring module. The monitoring module verifies a threat based on the images. The system also includes a neutralizing module that neutralizes the threat as directed by the monitoring module. The preceding subject matter of this paragraph characterizes example 6 of the present disclosure.

The neutralizing module neutralizes the thread by controlling one or more of noise, pepper spray, tear gas, and rubber bullets. The preceding subject matter of this paragraph characterizes example 7 of the present disclosure, wherein example 7 also includes the subject matter according to example 6, above.

The system additionally includes a tagging module that controls dispensing of tagging material toward the threat. The preceding subject matter of this paragraph characterizes example 8 of the present disclosure, wherein example 8 also includes the subject matter according to any one of examples 6-7, above.

The system further includes one or more bullet-proof cases. A bullet-proof case in the one or more bullet-proof cases encases at least one of the devices associated with the monitoring module, the activation module, the image sensing module, the neutralizing module, and the tagging module. The preceding subject matter of this paragraph characterizes example 9 of the present disclosure, wherein example 9 also includes the subject matter according to example 8, above.

The system further includes a targeting module that provides targeting for the neutralizing module and the tagging module. The preceding subject matter of this paragraph characterizes example 10 of the present disclosure, wherein example 10 also includes the subject matter according to any one of examples 8-9, above.

The monitoring module automatically activates the alert when indications of gunfire are detected by at least one of the monitoring module, the activation module, and the image sensing module. The preceding subject matter of this paragraph characterizes example 11 of the present disclosure, wherein example 11 also includes the subject matter according to any one of examples 6-10, above.

The monitoring module controls auditory output on one or more speakers. The preceding subject matter of this paragraph characterizes example 12 of the present disclosure, wherein example 12 also includes the subject matter according to any one of examples 6-11, above.

The system further includes an access module in communication with the monitoring module. The access module limits mobility of the threat within the area. The preceding subject matter of this paragraph characterizes example 13 of the present disclosure, wherein example 13 also includes the subject matter according to any one of examples 6-12, above.

The access module controls one or more doors. The access module limits mobility of the threat by locking the one or more doors. The preceding subject matter of this paragraph characterizes example 14 of the present disclosure, wherein example 14 also includes the subject matter according to example 13, above.

The system additionally includes a notification module that automatically sends notifications to people affected by the threat. The preceding subject matter of this paragraph characterizes example 15 of the present disclosure, wherein example 15 also includes the subject matter according to any one of examples 6-14, above.

The notification module communicates through the activation module to notify the people affected by the threat. The preceding subject matter of this paragraph characterizes example 16 of the present disclosure, wherein example 16 also includes the subject matter according to example 15, above.

The activation module automatically transmits a location of the threat to the monitoring module. The preceding subject matter of this paragraph characterizes example 17 of the present disclosure, wherein example 17 also includes the subject matter according to any one of examples 6-16, above.

The monitoring module is controllable by at least one of remotely located personnel and locally located personnel. The preceding subject matter of this paragraph characterizes example 18 of the present disclosure, wherein example 18 also includes the subject matter according to any one of examples 6-17, above.

The activation module establishes two-way voice communication with the monitoring module. The preceding subject matter of this paragraph characterizes example 19 of the present disclosure, wherein example 19 also includes the subject matter according to any one of examples 6-18, above.

Further disclosed herein is a program product comprising a non-transitory computer-readable storage medium storing code executable by a processor to activate an alert that includes threat information, the threat information describing a threat. The code is also executable by a processor to receive the alert at a remote location. Further, the code is executable by a processor to identify a location for the threat based on the threat information. Additionally, the code is executable by a processor to display a video image of the threat at the remote location. Moreover, the code is executable by a processor to aim a threat contact device at the threat in response to user directions from a user viewing the display video image. The code is further executable by a processor to activate the threat contact device in response to the user directions. The preceding subject matter of this paragraph characterizes example 20 of the present disclosure.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a block diagram of a system for suppression of physical threats, according to one or more examples of the present disclosure;

FIG. 2 is a diagram of an activation device; according to one or more examples of the present disclosure;

FIG. 3 is a block diagram of a processor configured to provide suppression of physical threats, according to one or more examples of the present disclosure;

FIG. 4 is a block diagram illustrating a processor configured to provide suppression of physical threats, according to one or more examples of the present disclosure;

FIG. 5 is a schematic flow diagram of a method for suppression of physical threats, according to one or more examples of the present disclosure; and

FIG. 6 is a schematic flow diagram of a method for suppression of physical threats, according to one or more examples of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

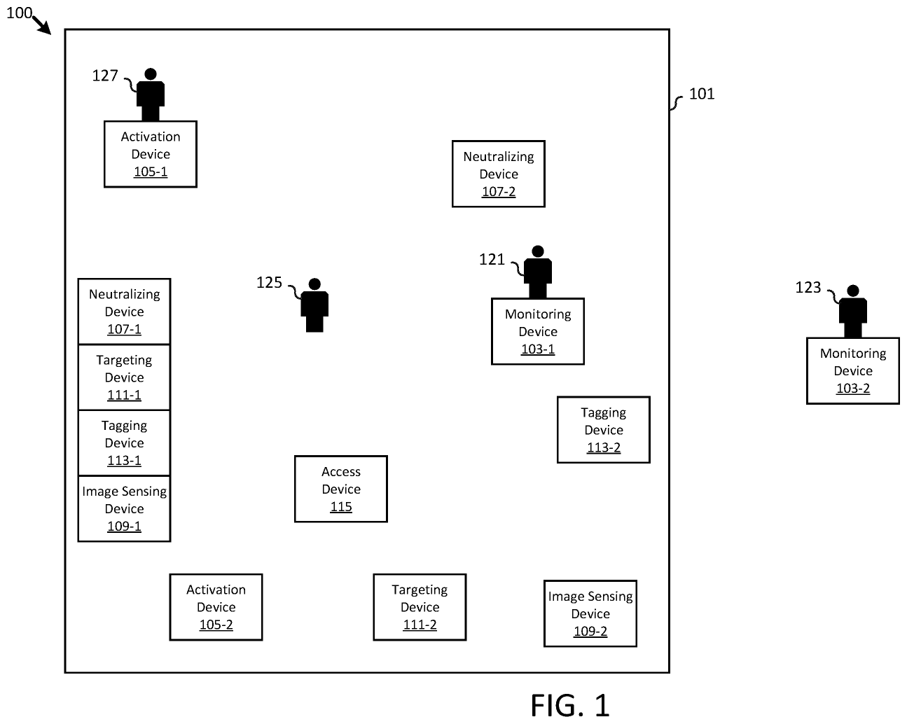

FIG. 1 is a block diagram illustrating one embodiment of a system 100 for suppressing physical threats. The system 100, in certain embodiments, is associated with an area 101. As used herein, an area 101 may refer to a region that is monitored by a security system. For example, the area 101 may refer to regions within buildings, such as a school, a bank, an office building, a stadium, a church, government buildings, a home, and the like. Additionally, the area 101 may also include property appertaining to monitored regions.

For many years, violent acts have threatened the safety of people gathered at various locations such as locations associated with a particular area 101. Acts have also threatened valuable property located at these various locations. To limit and/or prevent the acts, people have implemented security solutions that have taken one of two forms. In a first security solution, people have hired physical security personnel, both armed and unarmed, to be present at an area 101 at all times. To have physical security personnel present at all times within a region may be expensive. Also, the success of this solution depends on people willing to risk their own safety to address identified threats. As seen in news reporting, not all security personnel willingly risk their own safety when violent acts threaten normal people.

In a second security solution, people have developed technological systems that control access to the area 101 and monitor the area 101 for suspicious activity. When these technological systems detect suspicious activity, the systems may contact remotely located security personnel that can be dispatched to the area 101 to address the detected suspicious activity. While the second security solution is less expensive than the first security solution, the second security solution is not fully effective. In part, the second security solution may take too long to address the threat as people need to arrive at the area 101 after the threat is detected by the technological system. During this time gap, a violent individual may be able to continue violent actions without interference. Additionally, like the first security solution, the second security solution also relies on people willing to risk their own safety to address the threat.

To more effectively address threats, in certain embodiments, the system 100 may include one or more monitoring devices 103. As used herein, a monitoring device 103 may refer to a device that monitors the security for an area 101 and manages other security devices within the area 101. In some embodiments, the system 100 may include a local monitoring device 103-1 and a remote monitoring device 103-2. The local monitoring device 103-1 may be located within the area 101 and the remote monitoring device 103-2 may be located at a location outside of the area 101. As described herein, the local monitoring device 103-1 and the remote monitoring device 103-2 may be referred to generally and/or collectively as monitoring devices 103.

In further embodiments, the monitoring devices 103 may be monitored by an individual. For example, local security personnel 121 assigned to the area 101 may be stationed at a safe location that contains the monitoring device 103-1, where the safe location is within the area 101. At this safe location, the local security personnel 121 may monitor the area 101 through the monitoring device 103-1 for threats that may arise within the area 101. Alternatively, law enforcement or other security personnel 123 may monitor the area 101 through the remote monitoring device 103-2. For example, a police station may have a monitoring device 103-2 that is connected to devices at one or more areas 101. When a threat 125 occurs within the area 101, a remote security personnel 123, such as a police officer, may monitor the situation within the area 101 through the monitoring device 103-2.

The monitoring devices 103 may be connected to one or more devices within the area 101 to monitor threats that may arise. The monitoring devices 103 may be connected to the one or more devices using LTE, WiMAX, WiFi, Ethernet, modem, Bluetooth, BTLE, Zigbee, IP, RF, or other type of communicative technology. In certain embodiments, the monitoring device 103 may be connected to one or more activation devices 105. An activation device 105 may be a device that may be activated by an activating individual 127 when the activating individual 127 observes a threat 125 within the area 101. As described herein, a threat 125 may refer to anything that may cause physical harm to individuals or cause damage to property. In some embodiments, the threat 125 may be an individual that poses a threat to themselves. Some examples of the threat 125 may include a weapon wielding individual, a person exhibiting a mental illness, a stray animal, or other individual that may pose a risk.

As described herein, the activation device 105 may be a device that is activatable by an activating individual 127 in response to the individual 127 seeing a threat 125 in the area 101. The activation device 105 may be a hand-held beacon device, a wall mounted alarm, a cell phone application, a computer application, an internet website, and the like. Also, the activation device 105 may be fixedly attached to a wall, furniture, a floor, a ceiling, or other location within the area 101. As described above, an activation device 105 may communicate with the monitoring device 103 through one or more of multiple communication technologies.

As shown in FIG. 1, the system 100 includes multiple activation devices. For example, a first activation device 105-1, associated with the activating individual 127, and a second activation device 105-2. As used herein, the activation devices 105-1 and 105-2 may be referred to collectively and generally as activation device(s) 105. The first activation device 105-1 may be associated with a first location within the area 101 and the second activation device 105-2 may be associated with a second location within the area 101. Alternatively, the activation devices 105-1 and 105-2 may include different types of activation devices. For instance, the first activation device 105-1 may be mobile and located on the activating individual 127 while the second activation device 105-2 may be fixedly tied to a location within the area 101.

In some embodiments, when the activating individual 127 activates the activation device 105, the activation device 105 may send an alert to the monitoring device 103. As used herein, an alert refers to a transmitted signal that indicates that a threat 125 has been seen within the area 101. In certain embodiments, upon receiving the alert from the activation device 105, security personnel 121 or 123 may use the monitoring device 103 to monitor the threat 125. Further, the security personnel 121 and/or 123 may direct other devices within the area 101 to neutralize the threat 125.

In certain embodiments, the monitoring device 103 may be connected to one or more image sensing devices 109. As used herein, an image sensing device 109 may refer to a device that acquires image or video information about the environment containing a particular image sensing device 109. For example, the image sensing device 109 may be a closed circuit security camera, a cell phone camera, a digital assistant device, and the like. Additionally, the image sensing device 109 may include sensors that are designed to detect particular threats. For example, an image sensing device 109 may include an infrared sensor to detect threats 125 such as a fire within the area 101. In some embodiments, the system 100 may include multiple cameras associated with different locations within the area 101. For example, the system 100 may include a first image sensing device 109-1 and a second image sensing device 109-2. The first image sensing device 109-1 and the second image sensing device 109-2 may be associated with different locations within the area 101. As used herein, the different image sensing devices 109-1 and 109-2 may be referred to generally and collectively as the image sensing device(s) 109.

In some embodiments, when the monitoring device 103 receives an alert about a threat 125 from an activation device 105, the monitoring device 103 may acquire image information about the threat 125. For example, upon receiving the alert, the monitoring device 103 may identify the location of the activation device 105 that generated the alert. When the location of the activation device 105 is identified, the monitoring device 103 may identify one or more image sensing devices 109 that are closest to the determined location of the activation device 105. The monitoring device 103 may then acquire image information from the one or more image sensing devices 109 to monitor the activity of the threat 125. Upon receiving the image information from the image sensing devices 109, one or both of the local security personnel 121 at the local monitoring device 103-1 or the remote security personnel 123 at the remote monitoring device 103-2 may use the image information to verify that a threat 125 exists within the area 101.

In certain embodiments, using the image information from the one or more image sensing devices 109, the monitoring device 103 may attempt to limit the ability of the verified threat 125 to cause harm to both life and property. For example, the monitoring device 103 may control one or more devices that directly interfere with the activity of the threat 125. For example, the monitoring device 103 may control one or more access devices 115. As used herein, the access device 115 controls the ability of the threat 125 to move throughout the area 101. The access device 115 may be a door, a window, movable walls or other devices that could limit the ability of the threat 125 to move to other locations within the area 101. In some embodiments, when the monitoring device 103 identifies the location of the threat 125, the monitoring device 103 may control the one or more access devices 115 to keep the threat 125 at a particular location. For example, where the access devices 115 are doors, the monitoring device 103 may lock the doors around the threat 125. Alternatively, the monitoring device 103 may control the one or more access devices 115 to direct the threat 125 to move toward a desired location. For example, the monitoring device 103 may lock most of the doors around the threat 125 to limit the possible paths that the threat 125 may choose, to encourage the threat 125 to move toward a particular location within the area 101.

In a further embodiment, the monitoring devices 103 may control one or more targeting devices 111 to more accurately identify the position of the threat 125 within the area 101. As used herein, a targeting device 111 may refer to a device that is able to precisely identify the location of the threat 125 within the area 101. In some embodiments, the targeting device 111 may also track the movement of the threat 125 as the threat 125 moves through the area 101. Further, the targeting device 111 may be physically attached to or part of an image sensing device 109. Alternatively, the targeting device 111 may be physically separate from the image sensing device 109. For example, the system 100 may include a first targeting device 111-1 that is physically attached or part of a first image sensing device 109-1. Also, the system 100 may include a second targeting device 111-2 that is not attached to either the image sensing device 109-1 or the image sensing device 109-2. As used herein, the first targeting device 111-1 and the second targeting device 111-2 are referred to generally and collectively as targeting device(s) 111.

In some embodiments, to precisely identify the position of the threat 125, the targeting device may simply identify the location of the threat 125 in the images provided by the image sensing device 109. For example, where the targeting device 111 is physically attached to or part of an image sensing device 109, the targeting device 111 may identify the threat 125 within the image information provided by the image sensing device. Alternatively, where the targeting device 111 is located at a different location from the image sensing device 109, the targeting device 111 may use one or more locating technologies to identify the location of the threat 125 within the area 101. For example, the targeting device 111 may use one or more of stereoscopy, LiDAR, among other locating technologies to precisely locate the threat 125 within the area 101.

In certain embodiments, when the threat 125 is targeted by one or more targeting devices 111, the security personnel 121 located at a monitoring device 103 may attempt to neutralize the threat 125 using one or more neutralizing devices 107. As used herein, a neutralizing device 107 refers to a device that interacts with the threat 125 in such a way to remove or reduce the potential harm that could be caused by the threat 125. For example, the neutralizing device 107 may attempt to neutralize the threat 125 by spraying chemicals (such as tear gas, pepper spray, and the like) at the threat 125, firing projectiles (such as rubber bullets) at the threat 125, making noises to distract the threat 125, and/or other means capable of neutralizing or limiting the ability of the threat 125 to cause harm. In an additional example, where the threat 125 is a fire, the neutralizing device 107 may spray fire retardant towards the threat 125.

In a similar manner to the targeting device 111, the neutralizing device 107 may be physically located with an image sensing device 109. Alternatively, the neutralizing device 107 may be located at a different location within the area 101 from the image sensing devices 109. For example, a first neutralizing device 107-1 may be located at the same location as an image sensing device 109-1, while a second neutralizing device 107-2 may be located at a different location from the image sensing devices 109 within the area 101. Also, as used herein, the first neutralizing device 107-1 and the second neutralizing device 107-2 may be referred to generally or collectively as neutralizing device(s) 107.

In some embodiments, when the threat 125 is targeted by one or more targeting devices 111, security personnel 121 or 123 located at a monitoring device 103 may attempt to tag the threat 125 using one or more tagging devices 113. As used herein, a tagging device 113 refers to a device that projects a marker towards the threat 125 to aid in subsequent identification of the threat 125. For example, the tagging device 113 may fire a paintball, colored powder, ink, or other marking agent toward the threat 125 such that the threat 125 becomes temporarily marked. By marking the threat, it may be easier to identify the threat 125 if it moves to other locations within the area 101. Also, marking the threat 125 may prevent the threat 125 from being able to blend in with a group of people in the event that the threat 125 is able to flee the area 101.

In a similar manner to the targeting device 111, the tagging device 113 may be physically located with an image sensing device 109. Alternatively, the tagging device 113 may be located at a different location within the area 101 from the image sensing devices 109. For example, a first tagging device 113-1 may be located at the same location as an image sensing device 109-1, while a second tagging device 113-2 may be located at a different location from the image sensing devices 109 within the area 101. Also, as used herein, the first tagging device 113-1 and the second tagging device 113-2 may be referred to generally or collectively as neutralizing device(s) 113.

In certain embodiments, the system 100 may include protective measures to prevent the destruction of the various devices in the system 100 by a threat 125. For example, bullet proof cases may be used to protect the devices from gun fire. Also, the devices may be made from ruggedized material to prevent damage from drops, shocks, water, heat, and other environmental hazards. Accordingly, the system 100 may be protected from damage such that it can suppress threats in extreme circumstances.

As described above, in connection with FIG. 1, a monitoring device 103 (either remotely or locally located) may control various devices within an area 101 to reduce the harm posed by a threat 125 within an area 101. When alerted to a potential threat 125 by an activation device 105, the monitoring device 103 may acquire image data from image sensing devices 109 and verify that a threat 125 is present within an area 101. Upon verifying the threat, the monitoring device 103 may target the location of the threat 125 within the area 101 using a targeting device 111. When the threat 125 is targeted, the monitoring device 103 may direct a neutralizing device 107 to attempt to neutralize the danger posed by the threat 125. Also, the monitoring device 103 may direct a tagging device 113 to fire a marking agent towards the threat 125. By attempting to neutralize and mark the threat 125 through a monitoring device 103, the harm posed by the threat 125 may be responded to quickly without relying on security personnel choosing to put themselves in harm's way.

As described herein, the system 100 may be able to neutralize threats 125 associated with school shootings. In school shootings, it is important to quickly neutralize the threat 125, because the intention of the threat 125 is often to cause as much harm as possible before being either apprehended or killed. In a school shooting situation, the speed with which the threat 125 can be located and neutralized often depends on how long it takes for information regarding the event to reach someone in a position to neutralize the threat 125 and how long it takes for someone in position to respond and then neutralize the threat 125. As the system 100 offers a decentralized network of activation devices 105 in the hands (or near at hand) of multiple people throughout an area 101, the system 101 increases the number of people who can notify security personnel 121 or 123 when a threat 125 arises, thus reducing the notification time for security personnel. Also, by allowing security personnel 121 or 123 to neutralize the threat 125 remotely and nearly immediately upon receiving an alert, the system 100 reduces the time between notification of the event and neutralization of the threat 125. Further, by tagging the perpetrator for subsequent identification, the system 100 reduces the possibility of the threat 125 escaping and blending in among victims or others present within the area 101.

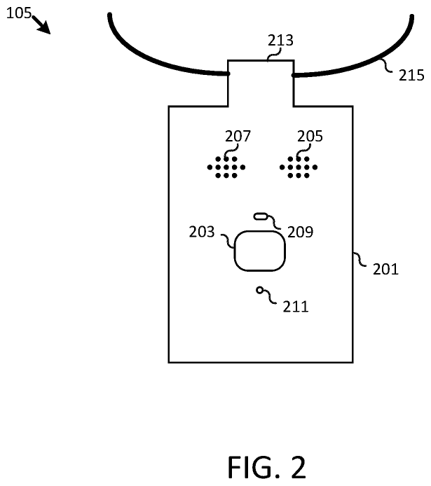

FIG. 2 is a diagram of an activation device 105 that may be portably carried by an individual, such as the activating individual 127 described above in FIG. 1. As illustrated, the activation device 105 may include a body 201. The body 201 may be made of plastic, metal, or other material that houses electronics for generating an alert and communicating the alert to a monitoring device 103. Also, the body 201 may also include an interface, wherein an activating individual 127 may interact with the activation device 105. For example, the body 201 may include an activation feature 203. As used herein, the activation feature 203 may refer to a feature through which an activating individual 127 may direct the activation device 105 to generate an alert. For example, the activation feature 203 may be a button, a switch, or other activatable feature.

In some embodiments, the activation device 105 may have a microphone 205 and a speaker 207. Upon generation of the alert, security personnel 121 or 123 located at the monitoring device 103 may desire further information regarding the situation associated with the alert. The security personnel 121 or 123 may communicate with the activating individual 127 through the microphone 205 and the speaker 207 of the activation device 105 to acquire the desired information. Also, the microphone 205 may function in place of the activation feature 203. For example, an individual 127 may direct the activation device 105 to generate an alert when the individual 127 speaks a particular phrase or word. By generating an alert in response to a spoken phrase or word, an activating individual 127 may direct the generation of an alert even if the activation device 105 is not within the reach of the individual.

Further, the activation device 105 may have one or more indicators 209 and 211. As used herein, the indicators 209 and 211 may be light emitting diodes that indicate a state of or other information describing the activation device 105 to an individual 127. For example, the indicator 209 and 211 may indicate whether the activation device 105 has generated an active alert. When the indicators 209 and 211 indicate whether the activation device 105 is subject to an active alert, the indicators 209 and 211 may be controllable by one of the monitoring devices 103. Also, the indicators 209 and 211 may indicate the state of a battery or other operational state of the activation device 105. Further, the indicators 209 and 211 may indicate whether or not the activation device 105 is communicatively connected to a monitoring device 103.

In certain embodiments, the body 201 of the activation device 105 may have an attaching tab 213 formed thereon. The attaching tab 213 may facilitate the wearing of the activation device 105 by an individual, such as the activating individual 127. As shown, an attaching means 215 is connected to the attaching tab 213. The attaching means 215 may be a clip, a lanyard, a string, a necklace, a magnet, or other means through which an activating individual 127 may portably attach the activation device 105 to oneself.

As shown in FIG. 2, the activation device 105 is wearable by an activating individual 127, but as described above in connection with FIG. 1, the activation device 105 may also be fixedly mounted to a fixture within the area, such as a wall, floor, furniture, and the like. When the activation device 105 is mounted to a fixture, a proximate activating individual 127 may use the activation device 105 to generate an alert when the activating individual 127 perceives that there is a threat 125 within the area 101. Similar to the portable activation device 105 shown in FIG. 2, an activating individual 127 may communicate with security personnel 121 or 123 through the fixed activation device 105 regarding generated alerts.

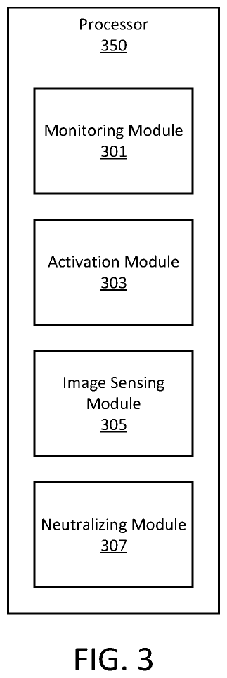

FIG. 3 is a block diagram of a processor 350 configured to provide suppression of physical threats. In certain embodiments, as used herein, the processor 350 may be a general-purpose computer, special-purpose computer, multiple processors, or other programmable data processing apparatus. In some embodiments, the processor 350 may be one or more processors located within the system 100 capable of suppressing physical threats. For example, the processor 350 may be located on one or more of the monitoring device 103, the activation device 105, the image sensing device 109, the neutralizing device 107, the tagging device 113, the access device 115, and the targeting device 111 as described above in connection with FIG. 1. For example, the processor 350 may include a monitoring module 301, an activation module 303, an image sensing module 305, and a neutralizing module 307. As described herein, the monitoring module 301 monitors an area 101 for threats 125. Further, as described herein, the activation module 303 sends signals to the monitoring module 301 that indicate that a threat 125 exists within an area 101. Also, as described herein, the image sensing module 305 captures images of the area 101 for use by the monitoring module, where the monitoring module 301 verifies the threat 125 based on the images. Additionally, as described herein, the neutralizing module 307 may neutralize a threat 125 as directed by the monitoring module 301.

In certain embodiments, the monitoring module 301 monitors an area 101 for threats. As described above, the monitoring module 301 may be located on the monitoring device 103, where the monitoring device 103 is located locally, remotely, or distributed both locally and remotely. To monitor threats that occur, the monitoring module 301 communicates with and manages multiple devices within an area 101 as directed by security personnel 121 or 123. For example, the security personnel 123 that direct the operation of the monitoring module 301 may be remotely located personnel (such as law enforcement) or locally located personnel (such as a security guard). Accordingly, the monitoring module 301 responds to threats 125 as they arise within a monitored area 101.

In some embodiments, the monitoring module 301 responds to alerts generated by the activation module 303. The activation module 303 generates alerts when an activating individual 127 indicates to the activation module 303 that a threat 125 exists within an area 101 as described above with respect to the activation device 105 in FIG. 1. To generate the alert, the activation module 303 may send a signal to the monitoring module 301 that indicates that a threat 125 exists within the area 101. When, the monitoring module 301 receives the alert from the activation module 303, the monitoring module 301 may attempt to establish two-way voice communication with the activation module 303 to gather additional information regarding the threat 125. In additional embodiments, as part of the sent signal, the activation module 303 may also send a location for the activation device 105 or for the threat 125 to the monitoring module 301. To acquire the location, the activation module 303 may acquire a location through GPS, an internal inertial measurement unit, or other location device type. In some embodiments, the activation module 303 may send the location at the discretion of the activating individual 127. Conversely, the activation module 303 may send the location automatically with the alert that was sent to the monitoring module 301.

In some embodiments, the monitoring module 301 may generate an alert without receiving a signal from the activation module 303 that instructs the monitoring module 301 to generate the alert. For example, certain detectable events may occur within the area 101 that may cause the monitoring module 301 to generate an alert. For example, if indications of gunfire are detected by any device (not just the activation devices 105) within the area 101, the monitoring module 301 may generate an alert. Other events that may cause the monitoring module 301 to automatically generate an alert may include explosions, fire, the detection of poisonous or dangerous chemicals, the destruction of one or more devices in the system 100, and the like.

In additional embodiments, the image sensing module 305 may provide images and videos of the threat 125 to the monitoring module 301 when an alert is generated by the monitoring module 301. For example, the activation module 303 may send a signal indicating that a threat 125 is present within the area 101. As part of the signal, the activation module 303 may send a location associated with the alert. The monitoring module 301 may then use the location information to acquire image information from the image sensing module 305, where the image information is associated with the location identified by the activation module 303. Using the image information, the monitoring module 301 may verify whether or not a threat 125 exists within the area 101. The monitoring module 301 may additionally verify whether or not a threat 125 exists within the area 101 based on voice communication between the activation module 303 and the monitoring module 301. When the threat 125 is verified, the image sensing module 305 may provide video to the monitoring module 301 to track the movements of the threat 125 through the area 101.

In certain embodiments, to prevent further harm from the threat 125, the monitoring module 301 may direct a neutralizing module 307 to neutralize the threat 125 within the area 101. For example, the monitoring module 301 may direct the neutralizing module 307 to fire rubber bullets at the threat 125. Additionally, the monitoring module 301 may direct the neutralizing module 307 to dispel chemical agents into the immediate location of the threat 125. Possible chemical agents may include tear gas, pepper spray, or other irritants that may inhibit the ability of the threat 125 to cause harm.

In additional embodiments, the neutralizing module 307 may control one or more speakers within the area 101. As such, security personnel 121 or 123 may direct the neutralizing module 307 to attempt to neutralize the threat 125 using loud sounds. Additionally, the neutralizing module 307 may allow security personnel 121 or 123 to speak into microphones that are connected to the speakers. The security personnel 121 or 123 may speak to the threat 125 to negotiate, calm down, or otherwise convince the threat 125 not to pursue a harmful course of action. Also, the neutralizing module 307 may allow the threat 125 to speak through a microphone to the security personnel 121 or 123. Accordingly, the monitoring module 301 may provide a centralized control point for controlling the neutralizing module 307 to quickly address a threat 125 that arises within an area 101 without exposing individuals to dangerous situations.

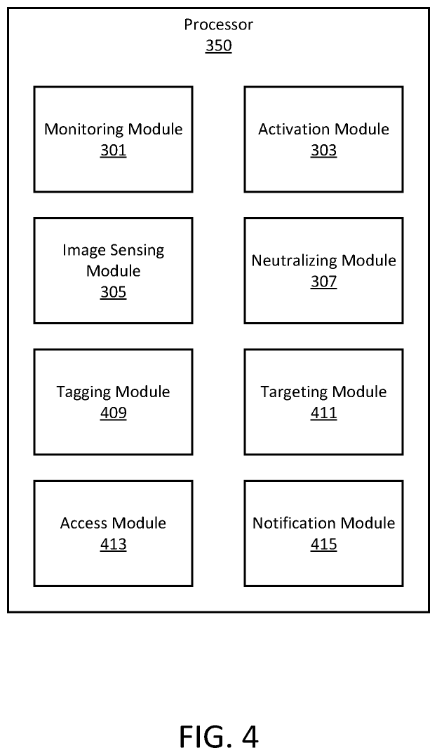

FIG. 4 is a block diagram illustrating a further embodiment of a processor 350 for the suppression of physical threats. The processor 350, in various embodiments, may be substantially similar to the processor 350 described above with regards to FIG. 3. In the depicted embodiment, the processor 350 may include a monitoring module 301, an activation module 303, an image sensing module 305, and a neutralizing module 307, which may be configured substantially similar as described above with regards to the monitoring module 301, the activation module 303, the image sensing module 305, and the neutralizing module 307 of FIG. 3. Additionally, the processor 350 may include a tagging module 409, a targeting module 411, an access module 413, and a notification module 415. In certain embodiments, the tagging module 409 controls the dispensing of tagging material towards the threat 125. In additional embodiments, the targeting module 411 targets the threat 125 for the neutralizing module 307 and the tagging module 409. In further embodiments, the access module 413 limits the mobility of the threat 125 within the area 101. Also, in some embodiments, the notification module 415 automatically sends notifications to people affected by the threat 125.

In certain embodiments, the tagging module 409 may dispense tagging material towards the threat 125 to mark the threat 125 for subsequent identification. For example, the monitoring module 301 may attempt to mark the threat 125 to facilitate future identification of the threat 125. Accordingly, users of the monitoring module 301 may direct the tagging module 409 to dispense tagging material at the location of the threat 125. For example, users of the monitoring module 301 may direct the tagging module 409 to fire paintballs, colored chalk powder, ink, or other marking material at the threat 125. As described above, the tagging material may facilitate subsequent identification of the threat 125.

In some embodiments, the targeting module 411 may target a location of the threat 125 to facilitate the tagging of the threat 125 by the tagging module 409 and/or the neutralizing of the threat 125 by the neutralizing module 307. As described above, both the neutralizing module 307 and the tagging module 409 may attempt to shoot objects or chemicals towards the threat 125. As the neutralizing module 307 and the tagging module 409 perform actions directed at the threat 125, the targeting module 411 may help the neutralizing module 307 and the tagging module 409 accurately and reliably affect the threat 125.

In further embodiments, the access module 413 may control the ability of the threat 125 to move through the area 101. For example, the access module 413 may control the accessibility of locations within the area 101. To control access to the different locations within the area 101, the access module 413 may control the locking of doors, windows, and other access features within the area 101. By locking doors, windows, and other access features, the access module 413 may limit the movement of the threat 125 or direct the threat 125 to move to a desired location within the area 101 or leave the area 101.

In certain embodiments, the access module 413 may attempt to prevent the threat 125 from moving from the location where the threat 125 is first seen. As such, when the monitoring module 301 identifies the location of the threat 125, the monitoring module 301 may direct the access module 413 to lock the doors that are proximate to the identified location of the threat 125. Accordingly, as the access module 413 traps the threat 125 at a location, the neutralizing module 307 and the tagging module 409 may attempt to neutralize and tag the threat 125. Also, law enforcement may go directly to the threat 125 without having to search through the area 101 for the threat 125.

In some embodiments, the access module 413 may attempt to direct the threat 125 to move towards a location within the area 101. For example, there may be locations within the area 101 that are not accessible by the tagging module 409 or the neutralizing module 307 or there may be a particular location within the area 101 where it is easier to apprehend the threat 125. Accordingly, the access module 413 may control doors and windows within the area 101 such that there are limited paths within the area 101 that the threat 125 may pursue.

In additional embodiments, the notification module 415 may send notifications through various channels to those affected by the threat 125. For example, the notification module 415 may provide an intercom system through which security personnel 121 or 123 can quickly notify people within an area 101 that a threat 125 is present within the area 101. Additionally, the notification module 415 may notify individuals in such a way that the threat 125 is unaware of the notification. For example, the notification module 415 may send a text message, email, voicemail, communication through an activation device 105, or other communication channel to notify individuals within the area 101 that a threat 125 is present. Additionally, the notification module 415 may notify family members or other people associated with those within an area 101 that is subject to a threat 125.

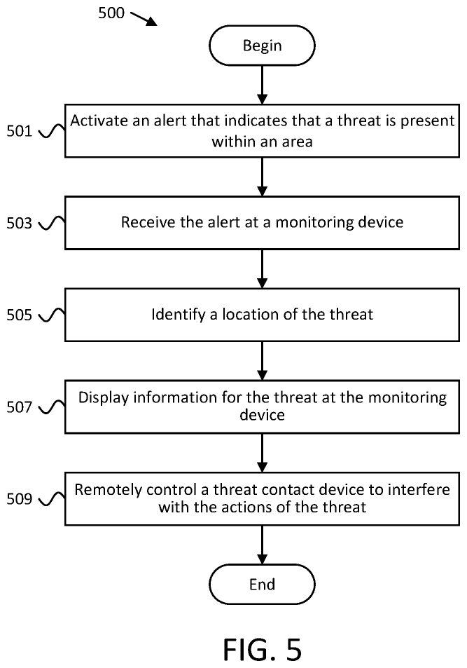

FIG. 5 is a schematic flow diagram of a method 500 for suppression of physical threats. In certain embodiments, the method 500 proceeds at 501, where an alert is activated that indicates that a threat 125 is present within an area 101. Additionally, the method 500 proceeds at 503, where the alert is received at a monitoring device 103. Further, the method 500 proceeds at 505, where a location of the threat 125 is identified. Also, the method 500 proceeds at 507, where information for the threat 125 is displayed at the monitoring device 103. Moreover, the method proceeds at 509, where a threat contact device is remotely controlled to interfere with the actions of the threat 125. As used herein, a threat contact device is a device that attempts to contact or interfere with the actions of the threat 125. For example, the threat contact device may be a neutralizing device 105 or a tagging device 113. When the threat contact device interferes with the actions of the threat 125, the method 500 ends.

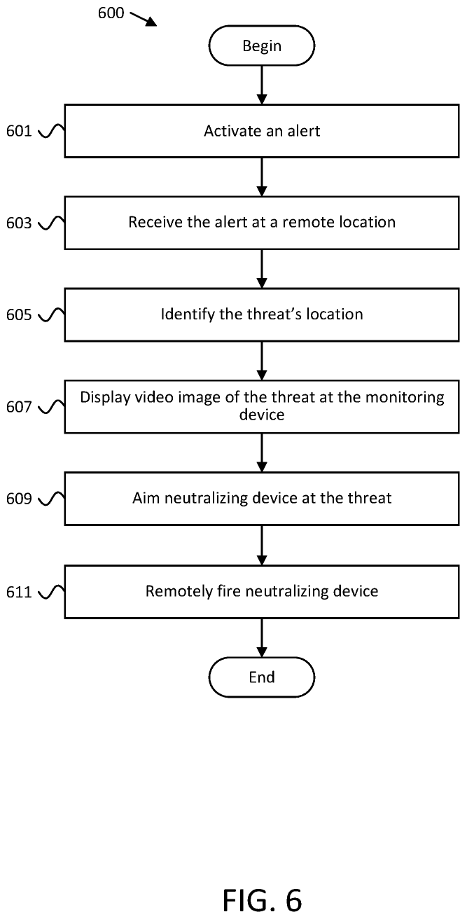

FIG. 6 is a schematic flow diagram of a further method for suppression of physical threats. In certain embodiments, the method 600 proceeds at 601, where an alert is activated. For example, an observant individual 127 may view a threat 125. When the individual 127 sees the threat, the individual 127 may access an activation device 105. When the individual 127 has the activation device 105, the individual 127 may activate the activation device 105 to generate an alert that a threat 125 is within an area 101. Additionally, the method 600 proceeds at 603, where the alert is received at a remote location. For example, when the activation device 105 generates an alert, the activation device 105 may transmit the alert to a monitoring device 103 that is located at a location not subject to the threat 125.

Further, the method 600 proceeds at 605, where the threat's location is identified. For example, when the activation device 105 sends the alert to the monitoring device 103, the activation device 105 may also send the location of the activation device 105 and/or the threat 125. Alternatively, when the monitoring device 103 receives an alert from the activation device 105, security personnel 121 or 123 at the monitoring device 103 may communicate with an individual 127 at the activation device 105 to acquire further information regarding the location of the threat 125.

Additionally, the method 600 proceeds at 607, where a video image of the threat 125 is displayed at the monitoring device 103. For instance, when the monitoring device 103 acquires the location of the threat 125, the monitoring device 103 may turn on an image sensing device 109 near the threat 125. The image sensing device 109 may then provide video imagery of the threat 125 for viewing on the monitoring device 103. The method 600 further proceeds at 609, where a neutralizing device 107 is aimed at the threat 125. For example, using the imagery data of the threat 125, security personnel 121 or 123 at the monitoring device 103 may aim a neutralizing device 107 at the threat 125. As discussed above neutralizing devices 107 may fire rubber bullets, tear gas, pepper spray, emit sound, or other object capable of neutralizing the threat 125. When the threat 125 is a fire, the neutralizing device 107 may spray fire retardant at the fire. The method 600 also proceeds at 611, where the neutralizing device 107 is remotely fired. For instance, when the neutralizing device 107 is aimed at the threat 125, security personnel 121 or 123 at the monitoring device 103 may direct the neutralizing device 107 to fire at the threat 125 so that the threat 125 is neutralized. The method 600 then ends.

Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Embodiments of the various modules may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

The modules may be implemented as a hardware circuit comprising custom very-large-scale integration (VLSI) circuits or gate arrays, off-the-shelf semiconductors such as logic chips, transistors, or other discrete components. The modules may also be implemented in programmable hardware devices such as field programmable gate arrays, programmable array logic, programmable logic devices or the like.

The modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized by the modules. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
activating an alert that indicates that a threat is present within an area;
receiving the alert at a monitoring device;
identifying a location of the threat based on monitoring information acquired by the monitoring device;
displaying information for the threat at the monitoring device; and
remotely controlling a threat contact device to interfere with actions of the threat based on the information for the threat.

2. The method of claim 1, wherein the threat contact device comprises at least one of a neutralizing device and a tagging device.

3. The method of claim 1, further comprising limiting mobility of the threat by locking one or more doors.

4. The method of claim 1, further comprising automatically sending notifications to people affected by the threat in response to the alert being activated.

5. The method of claim 1, further comprising enabling two-way communication between the monitoring device and a device associated with the alert.

6. A system comprising:
a monitoring module that monitors an area;
an activation module that sends signals to the monitoring module indicating that a threat exists within the area;
an image sensing module that captures images of the area for use by the monitoring module, wherein the monitoring module verifies the threat based on the images; and
a neutralizing module that neutralizes the threat as directed by the monitoring module.

7. The system of claim 6, wherein the neutralizing module neutralizes the threat by controlling one or more of noise, pepper spray, tear gas, and rubber bullets.

8. The system of claim 6, further comprising a tagging module that controls dispensing of tagging material towards the threat.

9. The system of claim 8, further comprising one or more bullet-proof cases, wherein a bullet-proof case in the one or more bullet-proof cases encases at least one of devices associated with the monitoring module, the activation module, the image sensing module, the neutralizing module, and the tagging module.

10. The system of claim 8, further comprising a targeting module that provides targeting for the neutralizing module and the tagging module.

11. The system of claim 6, wherein the monitoring module automatically activates an alert when indications of gunfire are detected by at least one of the monitoring module, the activation module, and the image sensing module.

12. The system of claim 6, wherein the monitoring module controls auditory output on one or more speakers.

13. The system of claim 6, further comprising an access module in communication with the monitoring module, wherein the access module limits mobility of the threat within the area.

14. The system of claim 13, wherein the access module controls one or more doors, wherein the access module limits the mobility of the threat by locking the one or more doors.

15. The system of claim 6, further comprising a notification module that automatically sends notifications to people affected by the threat.

16. The system of claim 15, wherein the notification module communicates through the activation module to notify the people affected by the threat.

17. The system of claim 6, wherein the activation module automatically transmits a location of the threat to the monitoring module.

18. The system of claim 6, wherein the monitoring module is controllable by at least one of:
remotely located law enforcement; and
locally located personnel.

19. The system of claim 6, wherein the activation module establishes two-way voice communication with the monitoring module.

20. A program product comprising a non-transitory computer-readable storage medium storing code executable by a processor to:
activate an alert that comprises threat information, the threat information describing a threat;
receive the alert at a remote location;
identify a location for the threat based on the threat information;
display a video image of the threat at the remote location;
aim a threat contact device at the threat in response to user directions from a user viewing the displayed video image; and
activate the threat contact device in response to the user directions.
